(19) United States
(12) Patent Application Publication
(10) Pub. No.: US 2011/0082029 A1
(43) Pub. Date: Apr. 7, 2011

(54) ALUMINA CARRIERS AND SILVER-BASED CATALYSTS FOR THE PRODUCTION OF ALKYLENE OXIDES

(76) Inventors: Erlind M. Thorsteinson, Charleston, WV (US); Madan M. Bhasin, Charleston, WV (US); Albert Cheng-Yu Liu, Charleston, WV (US); Juliana G. Serafin, Charleston, WV (US); Seyed R. Seyedmonir, Charleston, WV (US); Hwaili Soo, Charleston, WV (US)

(21) Appl. No.: 12/947,446

(22) Filed: Nov. 16, 2010

Related U.S. Application Data
(63) Continuation of application No. 10/567,178, filed on Feb. 3, 2006, now abandoned.
(60) Provisional application No. 60/497,452, filed on Aug. 22, 2003.

(51) Int. Cl. B01J 27/055; B01J 32/00; B01J 37/08; B01J 27/25

(52) U.S. Cl. 502/201; 502/439; 502/218

(57) ABSTRACT

An improved carrier useful for preparing a catalyst having excellent catalytic performance when used in the production of alkylene oxide, such as ethylene oxide. The carrier is obtained by a) impregnating a preformed alpha-alumina carrier with at least one modifier selected from among alkali metal silicates and alkaline earth metal silicates, b) drying the impregnated carrier; and c) calcining dried carrier. The carrier may optionally be washed, prior to being impregnated by conventional catalytic material and/or promoter material.

### CROSS-REFERENCE STATEMENT

This application claims the benefit of U.S. Provisional Application No. 60/497,452, filed Aug. 22, 2003.

### FIELD OF THE INVENTION

This invention relates to methods of making alumina carriers having desirable properties when used to support silver-based catalysts. This invention also relates to alumina carriers made using the methods of the invention, and to epoxidation reactions carried out in the presence of silver-based catalysts supported on such alumina carriers.

### BACKGROUND OF THE INVENTION

The production of alkylene oxide, such as ethylene oxide, by the reaction of oxygen or oxygen-containing gases with ethylene in the presence of a silver-containing catalyst at elevated temperature is an old and well-known art. For example, U.S. Pat. No. 2,040,782, dated May 12, 1936, describes the manufacture of ethylene oxide by the reaction of oxygen with ethylene in the presence of silver catalysts which contain a class of metal-containing promoters. In Reissue U.S. Pat. No. 20,370, dated May 18, 1937, Leforte discloses that the formation of olefin oxides may be effected by causing olefins to combine directly with molecular oxygen in the presence of a silver catalyst. (An excellent discussion on ethylene oxide, including a detailed description of commonly used manufacturing process steps, is found in Kirk-Othmer's Encyclopedia of Chemical Technology, 4^{th} Ed. (1994) Volume 9, pages 915 to 959).

The catalyst is the most important element in direct oxidation of ethylene to produce ethylene oxide. There are several well-known basic components of such catalyst: the active catalyst metal (generally silver as described above); a suitable support/carrier (for example alpha-alumina); and catalyst promoters, all of which can play a role in improving catalyst performance. Because of the importance of the catalyst in the production of ethylene oxide, much effort has been expended to improve catalyst's efficiency in producing ethylene oxide.

The use and/or incorporation of silica or certain silicates during the production of the support/carrier used to improve the performance of catalysts made based on such carrier is generally known and is disclosed in several prior art references: for example U.S. Pat. Nos. 4,272,443; 4,428,863; 4,575,494; 4,645,754; 4,769,358; 5,077,256; 5,100,859; 6,281,370; 6,313,325; and 6,579,825; WO 97/46317; and U.S. Patent Application No. 2003/00092922 A1. It should be noted, however, none of these references discloses or suggests what has been discovered in the present invention—the use of claimed silicates as a post-formation, additional treatment for the preformed carrier to further enhance the performance of the resultant silver-based catalysts prepared using such carrier.

Several terms are commonly used to describe some of the parameters of catalytic systems for epoxidation of alkenes. For instance, “conversion” is defined as the molar percentage of alkene fed to the reactor which undergoes reaction. Of the total amount of alkene which is converted to a different chemical entity in a reaction process, the molar percentage which is converted to the corresponding alkylene epoxide is known as the “efficiency” (which is synonymous with the “selectivity”) of that process. The product of the percent efficiency times the percent conversion (divided by 100 percent (%) to convert from %² to %) is the percentage “yield”, that is, the molar percentage of the alkene fed that is converted into the corresponding epoxide.

The “activity” of a catalyst can be quantified in a number of ways, one being the mole percent of alkylene epoxide contained in the outlet stream of the reactor relative to that in the inlet stream (the mole percent of alkylene epoxide in the inlet stream is typically, but not necessarily, zero percent) while the reactor temperature is maintained substantially constant, and another being the temperature required to maintain a given rate of alkylene epoxide production. That is, in many instances, activity is measured over a period of time in terms of the molar percent of alkylene epoxide produced at a specified constant temperature. Alternatively, activity may be measured as a function of the temperature required to sustain production of a specified constant mole percent of alkylene epoxide. The useful life of a reaction system is the length of time that reactants can be passed through the reaction system during which results are obtained which are considered by the operator to be acceptable in light of all relevant factors.

Deactivation, as used herein, refers to a permanent loss of activity and/or efficiency, that is, a decrease in activity and/or efficiency which cannot be recovered. As noted above, production of alkylene epoxide product can be increased by raising the temperature, but the need to operate at a higher temperature to maintain a particular rate of production is representative of activity deactivation. Activity and/or efficiency deactivation tends to proceed more rapidly when higher reactor temperatures are employed. The “stability” of a catalyst is inversely proportional to the rate of deactivation, that is, the rate of decrease of efficiency and/or activity. Lower rates of decline of efficiency and/or activity are generally desirable.

To be considered satisfactory, a catalyst must have acceptable activity and efficiency, and the catalyst must also have sufficient stability, so that it will have a sufficiently long useful life. When the efficiency and/or activity of a catalyst has declined to an unacceptably low level, typically the reactor must be shut down and partially dismantled to remove the catalyst. This results in losses in time, productivity and materials, for example, silver catalytic material and alumina carrier. In addition, the catalyst must be replaced and the silver salvaged or, where possible, regenerated. Even when a catalyst is capable of regeneration in situ, generally production must be halted for some period of time. At best, replacement or regeneration of catalyst requires additional losses in production time to treat the catalyst and, at worst, requires replacement of the catalyst with the associated costs. It is therefore highly desirable to find ways to lengthen the useful life of a catalyst.

Since even small improvements in useful life may have significance in large scale commercial production, it is desirable to obtain a carrier and resultant catalyst (as well as a method for achieving the same) having improved stability, along with acceptable efficiency.

### SUMMARY OF THE INVENTION

One aspect of the present invention relates to alumina carriers which provide improved activity and/or efficiency stability and acceptable initial efficiency and activity, and a method by which such carrier is made to improve the performance of already formed and fired carrier. More particularly the invention is directed to the concept of a post-treatment method to further improve carrier to be used in a catalyst for the production of alkylene oxide, for example ethylene oxide. Accordingly, this present invention provides a method for the preparation of a modified carrier for a catalyst to be used for the vapor phase epoxidation of alkene, comprising: a) impregnating a preformed alpha-alumina carrier with at least one modifier selected from among alkali metal silicates and alkaline earth metal silicates; b) drying said impregnated carrier; and c) calcining said dried carrier.

Another aspect of the present invention is optional washing of the modified carrier for further advantages.

Yet another aspect of the present invention is the modified carrier prepared pursuant to the method disclosed herein and catalyst based on such carrier. The improved catalyst of the present invention can also be prepared with optional incorporation of efficiency enhancing promoters well known in the art.

Another aspect of the present invention is a method of producing alkylene oxide, for example ethylene oxide using the catalyst prepared from the modified carrier of the present invention.

While the present invention is not limited by any theories, it is believed that a possible explanation for the mechanism of the modifications described above is that the modifier(s) react with surfaces of the microscopic alumina particles contained in the preformed alpha-alumina carrier, and as a result affect one or more properties, for example, roughness, degree of crystallinity, chemical composition, etc., of the surfaces of the microscopic alumina particles, without substantially altering the morphology, pore volume and/or pore size distribution, and in some cases surface area, of the preformed alpha-alumina carrier. As a result of this mechanism, it is believed, any of the modifications according to the present invention can be performed on alumina which has already been calcined, and which may preferably already have desirable morphology, surface area, pore volume and/or pore size distribution, to modify the surfaces of the preformed alpha-alumina carrier in a way which provides improved efficiency, activity and/or stability. It is a further feature of the present invention that the preformed alpha-alumina carrier may be a material which could be employed as a carrier as is, that is, without modification according to the present invention. For example, the preformed alpha-alumina carrier may comprise material which is suitable for use as a carrier for a silver-based epoxidation catalyst.

### DETAILED DESCRIPTION OF THE INVENTION

As mentioned above, there is provided a method of forming carrier for a catalyst, comprising impregnating preformed alpha-alumina carrier with at least one modifier selected from among alkali metal silicates and alkaline earth metal silicates to provide impregnated preformed alpha-alumina carrier; drying the impregnated preformed alpha-alumina carrier to provide dried impregnated alumina; and calcining the dried impregnated alumina to provide modified alumina carrier.

The preformed alpha-alumina carrier comprises alumina, that is, it may contain alumina substantially alone (with unavoidable or minor impurities) or in combination with one or more other materials.

The alumina for use according to this aspect of the invention is not limited, and can include any type of alumina suitable for use in making a carrier, such materials being well known and widely available. For example, alumina used in making carriers for silver-based catalysts, for example, for use in the production of alkylene epoxides, has been described extensively in the patent literature (some of the earlier such patents including, for example, U.S. Pat. Nos. 2,294,383, 3,172,893, 3,332,887, 3,423,328 and 3,563,914, the entireties of which are hereby incorporated herein by reference). There have been employed alumina which has a very high purity, that is, at least 98 wt. % alpha-alumina, any remaining components being silica, alkali metal oxides (for example, sodium oxide) and trace amounts of other metal-containing and/or non-metal-containing additives or impurities. Likewise, there have been employed alumina of lower purity, that is, about 80 wt. % alpha-alumina, the balance being one or more of amorphous and/or crystalline alumina and other alumina oxides, silica, silica alumina, mullite, various alkali metal oxides (for example, potassium oxide and cesium oxide), alkaline earth metal oxides, transition metal oxides (for example, iron oxide and titanium oxide), and other metal and non-metal oxides. In addition, the material used to make the carrier may comprise compounds which have been known for improving catalyst performance, for example, rhenium, (such as rhenates) and molybdenum.

The expression “preformed alpha-alumina carrier” is to be understood as encompassing any material obtained by performing (on alumina or on a composition which comprises alumina) any sequence of treatments which includes at least one calcining, that is, the expression “preformed alpha-alumina carrier” encompasses any of the many preformed alpha-alumina carrier materials which are commercially available. Methods according to the present invention therefore encompass, for example, methods in which a preformed alpha-alumina carrier material is used as a starting material, and the carrier is impregnated with a modifier, followed by drying and calcining, as well as methods comprising calcining alumina to form preformed alpha-alumina carrier, then impregnating the preformed alpha-alumina carrier with a modifier, followed by drying and calcining.

As described above, the modification according to the present invention can be conducted in such a way that properties of the surfaces of the microscopic alumina particles can be affected without substantially altering the morphology, surface area, pore volume, pore size distribution and/or bulk density of the preformed alpha-alumina carrier. As a result, where preformed alpha-alumina carrier having shape, morphology, surface area, pore volume, pore size distribution and bulk density which are desirable for a carrier is modified in accordance with the present invention, the resulting shape, morphology, surface area, pore volume, pore size distribution and bulk density of the modified alumina carrier are likewise desirable for a carrier. Accordingly, the preformed alpha-alumina carrier preferably has shape, morphology, surface area, pore volume, pore size distribution and bulk density shape which are desirable for alumina carrier.

Suitable shapes for the preformed alpha-alumina carrier therefore include any of the wide variety of shapes known for carriers, including particles, chunks, pieces, pellets, rings, spheres, wagon wheels, toroids having star shaped inner and/or outer surfaces, and the like of a size suitable for employment in fixed bed reactors. Conventional commercial fixed bed ethylene epoxide reactors are typically in the form of a plurality of parallel elongated tubes (in a suitable shell) about 1 to 3 inches O.D. and 15-45 feet long filled with catalyst. In such fixed bed reactors, it is desirable to employ carrier formed into a rounded shape, such as, for example, spheres, pellets, rings, tablets and the like, having diameters from about 0.1 inch to about 0.8 inch.

Representative examples of materials which can be employed as the preformed alpha-alumina carrier according to the present invention include alumina carriers manufactured by Süd Chemie, Inc., Louisville, Ky., and alumina carriers manufactured by the Saint-Gobain N or Pro Corporation, Akron, Ohio.

Of the many known methods for making preformed alpha-alumina carrier having desirable properties (for example, having desirable morphology, surface area, pore volume and/or pore size distribution), one such method comprises forming (for example, by extruding or pressing) alumina powder (preferably alpha-alumina powder) to provide formed alumina, followed by calcining to provide pills of preformed alpha-alumina carrier.

Another known method for making preformed alpha-alumina carrier having desirable properties comprises mixing alumina (preferably alpha-alumina) with a binder to provide a mixture, forming (for example, by extruding or pressing) the mixture to provide a formed mixture, and then calcining the formed mixture to provide pills of preformed alpha-alumina carrier.

The preformed alpha-alumina carrier of this method preferably has a pore size distribution wherein:

less than 20% (more preferably, 0 to 5%) by volume of the pores have a diameter of less than 0.1 micron;

5 to 30% (more preferably, 5 to 20%) by volume of the pores have a diameter of 0.1 to 0.5 microns;

7 to 30% (more preferably, 10 to 25%) by volume of the pores have a diameter of 0.5 to 1.0 micron;

greater than 10% (more preferably, 10 to 40%) by volume of the pores have a diameter of 1.0 to 10 microns;

greater than 20% (more preferably, 30 to 55%) by volume of the pores have a diameter of 10 to 100 microns; and

4 to 20% (more preferably, 6 to 20%) by volume of the pores have a diameter of at least 100 microns.

Another known method for preparing preformed alpha-alumina carrier having suitable properties comprises peptizing boehmite alumina and/or gamma-alumina in an acidic mixture containing halide anions (preferably fluoride anions) to provide halogenated alumina, forming (for example, by extruding or pressing) the halogenated alumina to provide formed halogenated alumina, drying the formed halogenated alumina to provide dried formed alumina, and calcining the dried formed alumina to provide pills of preformed alpha-alumina carrier. Where preformed alpha-alumina carrier is used which has been prepared as described above in this paragraph, it is important that the alumina which has been peptized with an acidic mixture containing halide anions be calcined before impregnation with the at least one modifier, because the halide is necessary for forming platelets of alpha-alumina in the preformed alpha-alumina carrier. If the halogenated alumina were impregnated with the at least one modifier without first calcining the halogenated alumina after peptizing the boehmite alumina and/or gamma-alumina, the at least one modifier would eliminate some or substantially all of the halide anions, which would then not be available for assisting in the formation of platelets of alpha-alumina.

The preformed alpha-alumina carrier made by this method (that is, prior to impregnation with at least one modifier according to the present invention) preferably has a specific surface area of at least about 0.7 m²/g (more preferably from about 0.7 m²/g to about 10 m²/g), a pore volume of at least about 0.5 cc/g (more preferably from about 0.5 cc/g to about 2.0 cc/g), purity of at least 98 weight percent alpha-alumina, median pore diameter from about 1 to about 50 microns. The preformed alpha-alumina carrier preferably includes particles each of which has at least one substantially flat major surface having a lamellate or platelet morphology which approximates the shape of a hexagonal plate (some particles having two or more flat surfaces), at least 50 percent of which (by number) have a major dimension of less than about 50 microns. The preformed alpha-alumina carrier, obtained by any suitable method as indicated above, is impregnated with the at least one modifier selected from among alkali metal silicates and alkaline earth metal silicates. This impregnation may be performed by any suitable method. One preferred method of impregnating the preformed alpha-alumina carrier is by dissolving the at least one modifier in a solvent to form an impregnation solution, and vacuum impregnating the preformed alpha-alumina carrier with the impregnation solution. Alternatively, a coating of a solution, emulsion or slurry containing the at least one modifier may be formed on the carrier.

Preferred impregnation compositions according to the present invention comprise at least one alkali metal silicate in solution, preferably in water. With regard to aqueous solutions, different alkali metal silicates are known to have different respective ranges of solubilities in different solvents, and so the ranges within which concentrations of alkali metal silicates can be selected are controlled by the solubilities of the particular alkali metal silicate compound employed. The impregnation composition may further contain one or more other material, for example, a promoter, a stabilizer, a surfactant or the like.

As mentioned above, according to the first aspect of the present invention, after impregnating the preformed alpha-alumina carrier with at least one modifier selected from among alkali metal silicates and alkaline earth metal silicates, the impregnated preformed alpha-alumina carrier is dried. The drying is preferably carried out at a temperature not exceeding about 250 degrees C. for at least the first two hours following the impregnation. Such drying can be carried out in any suitable way, for example, by placing the alumina in a dryer or by leaving the alumina standing in ambient conditions (for example, room temperature), for example, with or without humidity control and/or gas blowing, or any other treatment which results in drying. The invention is not limited to any particular method of drying, and this aspect of the invention encompasses all processes as described herein and in which drying is achieved, regardless of how such drying is achieved. It is preferred that for at least the first two hours following impregnation, the temperature of the alumina preferably does not exceed 250 degrees C. The drying is preferably conducted in a controlled manner, preferably including controlling humidity, to produce an even distribution of the modifier on the preformed alpha-alumina carrier.

In a specific representative embodiment of a drying treatment carried out in a drying oven, drying is conducted in a drying oven by slowly increasing the temperature to a maximum of from about 100 degrees C. to about 250 degrees C., most preferably a maximum of about 150 degrees C., over a period of from about 2 to 12 hours, most preferably about 4 to 6 hours, followed by cooling back to about room temperature in the next ½ hour to 2 hours. For example, a representative example of a suitable drying sequence includes placing impregnated preformed alpha-alumina carrier in a drying oven and slowly increasing temperature up to a maximum not greater than 150 degrees C. and holding at that temperature for a suitable length of time, for example, 2 to 12 hours. As another example, a different specific representative example of a suitable drying sequence includes increasing temperature from room temperature to about 50 degrees C. in the first 45 to 75 minutes, preferably 60 minutes, increasing temperature from about 50 degrees C. to about 75 degrees C. in the next 45 to 75 minutes, preferably 60 minutes, increasing temperature from about 75 degrees C. to about 100 degrees C. in the next 45 to 75 minutes, preferably 60 minutes, increasing temperature from 100 degrees C. to about 150 degrees C. in the next 45 to 90 minutes, preferably 60 minutes, holding temperature at about 150 degrees C. for the next 45 to 75 minutes, preferably 60 minutes, followed by cooling back to room temperature in the next 45 to 75 minutes. Another specific representative example of a possible drying sequence, this example including a higher maximum temperature, includes increasing temperature from room temperature to about 60 degrees C. in the first 45 to 75 minutes, increasing temperature from about 60 degrees C. to about 90 degrees C. in the next 20 to 30 minutes, increasing temperature from 90 degrees C. to 150 degrees C. in the next 45 to 75 minutes, increasing temperature from 150 degrees C. to 250 degrees C. in the next 50 to 80 minutes, followed by cooling back to room temperature.

The preformed alpha-alumina carrier, which has thus been impregnated with at least one modifier comprising at least one alkali metal silicate and/or at least one alkaline earth metal silicate and dried, is then calcined. If the impregnated preformed alpha-alumina carrier were not dried prior to being calcined, the at least one alkali metal silicate and/or at least one alkaline earth metal silicate would be less evenly distributed relative to the preformed alpha-alumina carrier and/or would be present in a lower overall amount. In other words, the drying of the present invention results in better uniformity of distribution of the at least one alkali metal silicate and/or at least one alkaline earth metal silicate and reduces or avoids losses of the at least one alkali metal silicate and/or at least one alkaline earth metal silicate while calcining the dried impregnated alumina.

The calcining of the dried impregnated alumina is carried out by raising the temperature of the dried impregnated alumina for a period of time. The maximum temperature to which the dried impregnated alumina is subjected is preferably at least 800 degrees C., more preferably at least 1200 degrees C.

An example of a suitable calcining includes placing the impregnated and dried carrier in a calcining furnace and increasing temperature from room temperature to about 500 degrees C. in the first 45 to 75 minutes, preferably about 60 minutes, holding at about 500 degrees C. for the next 45 to 75 minutes, preferably about 60 minutes, increasing temperature from about 500 degrees C. to about 800 degrees C. in the next 45 to 75 minutes, preferably about 60 minutes, holding at about 800 degrees C. for the next 45 to 75 minutes, preferably about 60 minutes, increasing temperature from about 800 degrees C. to about 1200 degrees C. in the next 45 to 75 minutes, preferably about 60 minutes, holding at about 1200 degrees C. for the next 90 to 150 minutes, preferably about 120 minutes, followed by substantially linearly cooling to 150 degrees C. over the next 8 to 12 hours, preferably about 10 hours, and then removing the carrier from the furnace and allowing it to cool, for example, down to room temperature. In some cases, it has been observed that calcining at temperatures higher than 1200 degrees C., for example, 1400 degrees C. or higher, results in a finished catalyst which has even slower aging, and so calcining to such higher temperatures (for example, 1400 degrees C.) is sometimes preferred.

While the present invention is not constrained in any way by any particular theory, it is believed that during the calcining, the at least one alkali metal silicate and/or at least one alkaline earth metal silicate can react with the alumina surfaces, particularly in instances where there was a relatively high concentration (for example, 2 wt. %) of the modifier (that is, at least one alkali metal silicate and/or at least one alkaline earth metal silicate) in the modifier impregnating solution. In the case where alpha-alumina is impregnated with sodium silicate modifier, such reacting is believed to result in the emergence of Na—Al—Si—O compounds in the alumina, for example, nepheline (NaAlSiO₄). The presence of nepheline is believed to signify that a reaction as referred to above in this paragraph has occurred, however, it has been found that good performance (that is, activity, efficiency and aging) is obtained whether or not nepheline is present in the modified carrier. If the temperature during the calcining carried out subsequent to the impregnation of alpha-alumina with sodium silicate is about 1400 degrees C., there is also formed carnegieite phase.

At the conclusion of the calcining following impregnation with the at least one modifier selected from among alkali metal silicates and alkaline earth metal silicates, the at least one alkali metal silicate and/or at least one alkaline earth metal silicate is present in an amount which is preferably in the range of from about 0.01 to about 5.0 weight percent, based on the total weight of the modified alumina carrier. Where the at least one modifier is sodium silicate, the sodium silicate is more preferably in the range of from about 0.5 to about 2.0 weight percent at the conclusion of the calcining following impregnation with the modifier.

As noted above, the modification of the present invention does not significantly affect the morphology and other structural properties of the unmodified alumina, although the present invention is not limited as such. For example, the morphology of the modified alumina carrier is typically substantially similar to that of the preformed alpha-alumina carrier (that is, prior to impregnation with the at least one modifier); the median pore diameter of the modified alumina carrier is typically no less than 80% of the median pore diameter of the preformed alpha-alumina carrier.

The specific surface area may or may not be substantially affected by the modification according to the present invention. The surface area of the modified alumina carrier is typically no less than about 80%, sometimes greater than about 90%, and sometimes greater than 95%, of the specific surface area of the preformed alpha-alumina carrier.

As noted above, the modified alumina carrier formed according to the present invention is preferably washed, prior to being impregnated by catalytic material and/or promoter material.

In accordance with one preferred method of washing according to the present invention, a Soxhlet extractor is employed to wash the modified carrier. Soxhlet extractors are well known to those of skill in the art, and basically include a column in which the modified alumina carrier can be positioned, below which is a supply of extractant, for example, water, which is heated to evaporation, whereupon it passes upward within the column and through the carrier to a condenser. Extractant which is condensed in the condenser falls down into the carrier, whereby the carrier becomes filled with the extractant. When the extractant overflows, it is siphoned back down and into the supply of extractant. In such an extraction according to the present invention, the extractant preferably comprises water and/or one or more amine, and the extraction is preferably conducted for a duration of from about 0.2 to about 144 hours, most preferably about 12 hours.

In accordance with other preferred methods for washing with the present invention, the modified alumina carrier can be impregnated by water and/or oxalate amine solutions and/or other solvents, followed by drying (for example, at a temperature of from about 25° C. to about 200° C., for example, about 120 degrees C.), or by roasting (for example, at a temperature of from about 100° C. to about 1000° C., for example, about 500 degrees C.).

At least a portion of any excess alkali metal cations, alkali metal silicate, alkaline earth cations, and/or alkaline earth metal silicate contained on the modified alumina carrier may be removed during such washing. It has also been observed that nepheline phase, if present, is generally not removed in significant quantities during such washing, whereas carnegieite phase, when present, tends to be removed in significant quantities during such washing.

Any of the carriers of the present invention may be impregnated with at least one catalytic material, and optionally also at least one promoter. Alternatively, a coating of the at least one catalytic material and/or the at least one promoter may be formed on the carrier by applying a solution, an emulsion or slurry containing the at least one catalytic material and/or the at least one promoter.

A variety of methods for impregnating carrier with at least one catalytic material (and preferably also at least one promoter, simultaneously with the catalytic material or in any sequence) are known.

For example, silver catalysts may be prepared by impregnating a carrier with a solution of one or more silver compounds, as is well known in the art. One or more promoters may be impregnated simultaneously with the silver impregnation, before the silver impregnation and/or after the silver impregnation. In making such a catalyst, the carrier is impregnated (one or more times) with one or more silver compound solutions sufficient to allow the silver to be supported on the carrier in an amount which is preferably in the range of from about 1% to about 70% of the weight of the catalyst, more preferably from about 10% to about 40% of the weight of the catalyst.

Catalytic material particle size is not narrowly critical. In the case of silver catalytic material, suitable particle size can be in the range of from about 100 to 10,000 angstroms.

There are a variety of known promoters, that is, materials which, when present in combination with particular catalytic materials, for example, silver, benefit one or more aspect of catalyst performance or otherwise act to promote the catalyst's ability to make a desired product, for example, ethylene oxide or propylene oxide. Such promoters in themselves are generally not considered catalytic materials. The presence of such promoters in the catalyst has been shown to contribute to one or more beneficial effects on the catalyst performance, for example, enhancing the rate or amount of production of desired product, reducing the temperature required to achieve a suitable rate of reaction, reducing the rates or amounts of undesired reactions, etc. Competing reactions occur simultaneously in the reactor, and a critical factor in determining the effectiveness of the overall process is the measure of control one has over these competing reactions. A material which is termed a promoter of a desired reaction can be an inhibitor of another reaction, for example, a combustion reaction. What is significant is that the effect of the promoter on the overall reaction is favorable to the efficient production of the desired product, for example, ethylene oxide. The concentration of the one or more promoters present in the catalyst may vary over a wide range depending on the desired effect on catalyst performance, the other components of a particular catalyst, and the epoxidation reaction conditions.

There are at least two types of promoters—solid promoters and gaseous promoters. A solid promoter is incorporated into the catalyst prior to its use, either as a part of the carrier support or as a part of active catalyst metal component applied thereto. During the reaction to make ethylene oxide, the specific form of the promoter on the catalyst may be unknown. When a solid promoter is added as a part of the active catalytic material (for example silver), the promoter can be added simultaneously with the material or sequentially following the deposition of the metal on the carrier or support. Examples of well-known solid promoters for catalysts used to produce ethylene oxide include compounds of potassium, rubidium, cesium, rhenium, sulfur, manganese, molybdenum, tungsten and mixtures thereof.

In contrast, the gaseous promoters are gas-phase compounds and or mixtures thereof which are introduced to a reactor for the production of alkylene oxide (for example ethylene oxide) with vapor-phase reactants, such as ethylene and oxygen. Such promoters further enhance the performance of a given catalyst, working in conjunction with or in addition to the solid promoters. Those typically employed are a gaseous inhibitor (chloride-containing compound), and/or one or more gaseous components capable of generating at least one efficiency-enhancing member of a redox half reaction pair, both of which are well known in the art. The preferred gaseous component capable of generating an efficiency-enhancing member of a redox half reaction pair is a nitrogen-containing component.

The solid promoters or modifiers are generally added as chemical compounds to the catalyst prior to its use. As used herein, the term “compound” refers to the combination of a particular element with one or more different elements by surface and/or chemical bonding, such as ionic and/or covalent and/or coordinate bonding. The term “ionic” or “ion” refers to an electrically charged chemical moiety; “cationic” or “cation” being positive and “anionic” or “anion” being negative. The term “oxyanionic” or “oxyanion” refers to a negatively charged moiety containing at least one oxygen atom in combination with another element. An oxyanion is thus an oxygen-containing anion. It is understood that ions do not exist in vacuo, but are found in combination with charge-balancing counter ions when added as a compound to the catalyst.

Once in the catalyst, the form of the promoter is not generally known, and the promoter may be present without the counterion added during the preparation of the catalyst. For example, a catalyst made with cesium hydroxide may be analyzed to contain cesium, but not its counterion hydroxide in the finished catalyst. Likewise, compounds such as alkali metal oxide, for example cesium oxide, and transition metal oxide, for example MoO₃, while not being ionic, may convert to ionic compounds during catalyst preparation or in use. For the sake of ease of understanding, the solid promoters will be referred to in terms of cations and anions regardless of their form in the catalyst under reaction conditions.

It is desirable that the catalytic material and optional one or more solid promoters be relatively uniformly dispersed on the modified carrier. A preferred procedure for depositing silver catalytic material and one or more promoters comprises: (1) impregnating a porous modified alumina carrier according to the present invention with a solution comprising a solvent or solubilizing agent, silver complex and one or more promoters upon the carrier, and (2) thereafter treating the impregnated carrier to convert the silver salt to silver metal and effect deposition of silver and the promoter(s) onto the exterior and interior pore surfaces of the carrier. For sake of repeatability, in the use and reuse of impregnating solutions, the carrier should preferably not contain undue amounts of ions which are soluble in the impregnating solution and/or exchangeable with the promoter supplied to the catalyst, either in the preparation or use of the catalyst, so as to significantly affect the amount of promoter which provides the desired catalyst enhancement. If the carrier contains such ions, the ions should generally be removed by standard chemical techniques such as leaching or washing, otherwise they must be taken into account during the catalyst preparation. Silver and promoter depositions are generally accomplished by heating the carrier at elevated temperatures to evaporate the liquid within the carrier and effect deposition of the silver and promoters onto the interior and exterior carrier surfaces. Impregnation of the carrier is the preferred technique for silver deposition because it utilizes silver more efficiently than coating procedures, the latter being generally unable to effect substantial silver deposition onto the interior surfaces of the carrier. In addition, coated catalysts are more susceptible to silver loss by mechanical abrasion.

Where the catalytic material is silver, the silver solution used to impregnate the carrier is preferably comprised of a silver compound in a solvent or complexing/solubilizing agent such as the silver solutions disclosed in the art. The particular silver compound employed may be chosen, for example, from among silver complexes, nitrate, silver oxide or silver carboxylates, such as silver acetate, oxalate, citrate, phthalate, lactate, propionate, butyrate and higher fatty acid salts. Silver oxide complexed with amines is a preferred form of silver for use in the present invention.

A wide variety of solvents or complexing/solubilizing agents may be employed to solubilize silver to the desired concentration in the impregnating medium. Among those disclosed as being suitable for this purpose are lactic acid (U.S. Pat. Nos. 2,477,436 to Aries, and 3,501,417 to DeMaio); ammonia (U.S. Pat. No. 2,463,228 to West, et al.); alcohols, such as ethylene glycol (U.S. Pat. Nos. 2,825,701 to Endler, et al., and 3,563,914 to Wattimina); and amines and aqueous mixtures of amines (U.S. Pat. Nos. 2,459,896 to Schwarz; 3,563,914 to Wattimina; 3,215,750 to Benisi; 3,702,259 to Nielsen; and 4,097,414, 4,374,260 and 4,321,206 to Cavitt).

Generally, the amount of silver compound that is dissolved in a silver impregnation solution is more than that ultimately provided on the finished catalyst per impregnation. For example, Ag₂O can be dissolved in a solution of oxalic acid and ethylenediamine to an extent of approximately 30% by weight. Vacuum impregnation of such a solution onto an alpha-alumina carrier of approximately 0.7 cc/g porosity typically results in a catalyst containing approximately 25% by weight of silver based on the entire weight of the catalyst. Accordingly, if it is desired to obtain a catalyst having a silver loading of greater than about 25 or 30%, and more, it would generally be necessary to subject the carrier to at least two or more sequential impregnations of silver, with or without promoters, until the desired amount of silver is deposited on the carrier. Preferably, two or more impregnations are used to make the catalysts of this invention. In some instances, the concentration of the silver salt is higher in the latter impregnation solutions than in the first. For example, if a total silver concentration of about 30% were desired in the catalyst, a low amount of silver, for example, about 10% by weight, could be deposited on the carrier as a result of the first impregnation, followed by a second silver impregnation depositing the remaining 20% by weight. In other instances, approximately equal amounts of silver are deposited during each impregnation. Often, to effect equal deposition in each impregnation, the silver concentration in the subsequent impregnation solutions may need to be greater than that in the initial impregnation solutions. In further instances, a greater amount of silver is deposited on the carrier in the initial impregnation than that deposited in subsequent impregnations. Each of the impregnations may be followed by roasting or other procedures to render the silver insoluble.

The impregnation or depositing of catalytic material and optional promoters on the surfaces of the modified alumina carrier can generally be in any sequence. Thus, impregnation and deposition of catalytic material and promoter may be effected coincidentally or sequentially, that is, one or more promoters may be deposited prior to, during, or subsequent to catalytic material addition to the carrier. Where more than one promoter is employed, they may be deposited simultaneously or sequentially.

Impregnation of the modified carrier with catalytic material may be effected using one or more solutions containing catalytic material and/or promoter in accordance with well-known procedures for coincidental or sequential depositions. In the case of a silver catalyst, for coincidental deposition, following impregnation, the impregnated modified carrier is heat or chemically treated to reduce the silver compound to silver metal and deposit the promoter onto the catalyst surfaces.

For sequential deposition, the modified carrier is initially impregnated with catalytic material or promoter (depending upon the sequence employed) and then heated or chemically treated as described above. This is followed by at least a second impregnation and a corresponding heat or chemical treatment to produce the finished catalyst containing silver and promoters.

Following each impregnation of the modified alumina carrier with catalytic material and/or promoter, the impregnated carrier is separated from any remaining non-absorbed solution. This is conveniently accomplished by draining the excess impregnating medium or, alternatively, by using separation techniques, such as filtration or centrifugation. The impregnated carrier is then generally heat treated (for example, roasted) to effect decomposition and reduction of the catalytic material, for example, silver metal compound (complexes in most cases), to metallic form and the deposition of promoter. Such roasting may be carried out at a temperature of from about 100 degrees C. to about 900 degrees C., preferably from about 200 degrees to about 700 degrees C., for a period of time sufficient to, for example, convert substantially all of any salt, for example, silver salt, to metal, for example, silver metal. Although a wide range of heating periods have been suggested in the art to thermally treat impregnated carrier (for example, U.S. Pat. No. 3,563,914 suggests heating for less than 300 seconds to dry, but not roast to reduce, the catalytic material; U.S. Pat. No. 3,702,259 discloses heating from 2 to 8 hours at a temperature of from 100 degrees C. to 375 degrees C. to reduce silver salt in the catalyst; and U.S. Pat. No. 3,962,136 suggests ½ to 8 hours for the same temperature range), it is only important that the reduction time be correlated with temperature such that substantially complete reduction of, for example, the silver salt to metal is accomplished. A continuous or step-wise heating program is desirably used for this purpose. Continuous roasting of the catalytic material for a short period of time, such as for not longer than ½ hour is preferred and can be effectively done in making the catalysts of this invention. When more than one roasting is carried out, it is not necessary that the roasting conditions be the same in each roasting.

Heat treatment may be carried out in air, alternatively, carbon dioxide, steam, nitrogen or other atmospheres may be employed. The equipment used for such heat treatment may use a static or flowing atmosphere of such gases to effect reduction, but a flowing atmosphere is much preferred.

It is sometimes desirable to avoid the use of strongly acidic or basic solutions which can attack the modified carrier and deposit impurities which can adversely affect the performance of the catalyst. The preferred impregnation procedure of U.K. Patent 2,043,481 (the entirety of which is hereby expressly incorporated herein by reference) coupled with the high roasting temperature, short residence time procedure which the patent also described may be especially beneficial in minimizing such catalyst contamination. Use of promoter salts coupled with the high purity carriers may allow one to use lower temperatures though short residence times.

The particular choice of solvent and/or complexing agent, catalytic material, heat treatment conditions and modified alumina carrier may affect, to varying degrees, the range of the size of the resulting silver particles on the carrier.

In a specific example of a suitable method for impregnating alpha-alumina carrier with silver, a desired amount of a complexing agent such as ethylenediamine (preferably high purity grade) is mixed with distilled water. Then, oxalic acid dihydrate (reagent grade) is added slowly to the solution at ambient temperature (about 23 degrees C.) while continuously stirring. During this addition of oxalic acid, the solution temperature typically rises to about 40 degrees C. due to the reaction exotherm. Silver oxide powder (Metz Corporation) is then added to the diamine-oxalic acid salt-water solution while maintaining the solution temperature below about 40 degrees C. Finally, monoethanolamine, aqueous alkali metal salt solution(s) and distilled water are added to complete the solution. The specific gravity of the resulting solution is typically in the range of from about 1.3 to 1.4 g/ml.

In another example of a suitable method, the carrier is impregnated with an aqueous solution prepared by dissolving a silver salt, such as silver carbonate, silver oxalate, silver acetate, silver propionate, silver lactate, silver citrate, or silver neodecanoate and a complexing agent such as triethenolamine, ethylene diamine, aminoethanolamine, or propylene diamine, drying the impregnated carrier, and then heat-treating the dried carrier in one or more steps or continuous temperature ramping or program to cause deposition of metallic silver in the form of minute particles on the inner and outer surfaces of the carrier. If silver nitrate is instead used as a silver salt, if an amine is used, care must be taken to make sure that the silver nitrate is present in amounts which are low enough to avoid explosion in combination with such amine. Except where otherwise noted, the Group element notation in this specification is as defined in the Periodic Table of Elements according to the IUPAC 1988 notation (IUPAC Nomenclature of Inorganic Chemistry 1960, Blackwell Publ., London). Therein, for example, Groups IV, V, VIII, XIV and XV correspond respectively to Groups IVb, Vb, IIIa, IVa and Va of the Deming notation (Chemical Rubber Company's Handbook of Chemistry & Physics, 48^{th} edition) and to Groups IVa, Va, IIIb, IVb, Vb of the IUPAC 1970 notation (Kirk Othmer Encyclopedia of Chemical Technology, 2^{nd} edition, Vol. 8, p. 94.

A wide variety of promoters are known in the art for use in conjunction with specific catalytic materials and reactions. In accordance with the present invention, a particularly preferred promoter is rhenium (for example, a rhenate ion). Where rhenium promoter is employed, the amount of rhenium is preferably in the range of from about 10 to about 10,000 ppm, more preferably from about 10010 about 1,000 ppm, (for example, a suitable amount of rhenium is about 350 ppm with a modified alumina carrier which comprises 1-2% sodium silicate modifier). It is further preferred, in many instances, to provide cesium promoter in addition to rhenium, as well as optionally further including cesium sulfate and/or manganese. Other suitable promoters include other alkali metals such as lithium, sodium, potassium and rubidium, and alkaline earth metals such as barium. Further examples of suitable promoters include halides, for example, fluorides and chlorides, and the oxyanions of the elements other than oxygen having an atomic number of 5 to 83 of Groups III-VII and XIII-XVII of the Periodic Table (for example, one or more of the oxyanions of nitrogen, sulfur, manganese, tantalum, molybdenum, tungsten and rhenium), as disclosed in U.S. Pat. No. 5,504,053, the entirety of which is hereby incorporated herein by reference. In addition, further suitable promoters are disclosed in U.S. Pat. Nos. 4,908,343 and 5,057,481, as well as the “prior art” as described in U.S. Pat. Nos. 4,908,343 and 5,057,481, the entireties of which are hereby incorporated herein by reference

For the sake of ease of understanding, promoters are often referred to in terms of cation promoters, for example, alkali metals and alkaline earth metals, and anion promoters. Compounds such as alkali metal oxide or MoO₃, while not being ionic, may convert to ionic compounds, for example, during catalyst preparation or in use. Whether or not such a conversion occurs, they are sometimes referred to herein in terms of cation and anion species, for example, alkali metal or molybdate.

When the catalyst comprises rhenium promoter, the rhenium component can be provided in any of various forms, for example, as the metal, as a covalent compound, as a cation or as an anion. Examples of rhenium compounds include rhenium halides, rhenium oxyhalides, rhenates, perrhenates, oxides of rhenium and acids of rhenium. Also, alkali metal perrhenates, alkaline earth metal perrhenates, silver perrhenates, other perrhenates and rhenium heptoxide can likewise be suitably utilized. Rhenium heptoxide, Re₂O₇, when dissolved in water, hydrolyzes to perrhenic acid, HReO₄, or hydrogen perrhenate. Thus, for purposes of this specification, rhenium heptoxide can be considered to be a perrhenate, that is, ReO₄⁻. Similar chemistries can be exhibited by other metals such as molybdenum and tungsten.

As for oxyanion promoters, mentioned above, U.S. Pat. No. 4,908,343 discloses catalysts in which as promoters there are employed mixtures of at least one cesium salt and one or more alkali metal and alkaline earth metal salts. In U.S. Pat. No. 4,908,343, the anions of cesium salts comprise oxyanions, preferably polyvalent oxyanions, of elements other than the oxygen therein having an atomic number of at least 15 to 83 and being from groups 3b through 7b, inclusive, of the Periodic Table of the Elements (as published by The Chemical Rubber Company, Cleveland, Ohio, in CRC Handbook of Chemistry and Physics, 46th Edition, inside back cover). In U.S. Pat. No. 4,908,343, the salts of the alkali metals and/or alkaline earth metals present comprise at least one of halide of atomic numbers of 9 to 53, inclusive, and oxyanions of elements other than oxygen therein having an atomic number of either (i) 7 or (ii) 15 to 83, inclusive, and selected from the groups 3a to 7a, inclusive, and 3b to 7b, inclusive, of the Periodic Table of the Elements. Often the catalyst contains at least one anion other than an oxyan ion of an element of groups 3b to 7b.

In U.S. Pat. No. 5,057,481, there are disclosed, as promoters, mixtures of cesium salts, at least one of which is a cesium salt in which the anions thereof are oxyanions, preferably polyvalent oxyanions, of elements having an atomic number of 21 to 75 and being from groups 3b through 7b, inclusive, of the Periodic Table of the Elements (as published by The Chemical Rubber Company, Cleveland, Ohio, in CRC Handbook of Chemistry and Physics, 46th Edition, inside back cover). The other anion or anions for cesium may be halide and/or oxyanion of elements other than oxygen therein having an atomic number of either (i) 7 or (ii) 15 to 83 and being from groups 3b to 7b, inclusive, and 3a to 7a, inclusive, of the Periodic Table. Frequently, the catalyst contains at least one anion other than an oxyanion of an element of groups 3b to 7b. The catalyst may contain other alkali metal and alkaline earth metal components which may be provided in the form of oxides, hydroxides and/or salts. Since cesium-containing components and other alkali metal and alkaline earth metal components are typically applied as solubilized components in a solvent, intermixing of the charge-satisfying moieties will occur. Hence, a catalyst prepared using cesium sulfate and potassium molybdate will also contain cesium molybdate and potassium sulfate.

The types of oxyanions suitable as counterions for the alkali and alkaline earth metals provided in the catalysts disclosed in U.S. Pat. No. 4,908,343, or the types of anion suitable as counterions for the cesium provided in the catalysts disclosed in U.S. Pat. No. 5,057,481 include by way of example, sulfate, SO₄⁻², phosphates, for example, PO₄⁻³, manganates, for example, MnO₄⁻², titanates, for example, TiO3⁻², tantalates, for example, Ta₂Oe, molybdates, for example, MoO₄⁻², vanadates, for example, V₂O₄⁻², chromates, for example, CrO₄⁻², zirconates, for example, ZrO₃⁻², polyphosphates, nitrates, chlorates, bromates, tungstates, thiosulfates, cerates, or the like. The halide ions include fluoride, chloride, bromide and iodide. It is well recognized that many anions have complex chemistries and may exist in one or more forms, for example, manganate (MnO₄⁻²) and permanganate (MnO₄^{-t}); orthovanadate and metavanadate; and the various molybdate oxyanions such as MoO₄⁻², Mo₇O₂₄⁻⁶ and Mo₂O₇⁻². While an oxyanion, or a precursor to an oxyanion, may be used in solution for impregnating carriers, it is possible that during the conditions of preparation of the catalyst and/or during use, the particular oxyanion or precursor initially present may be converted to another form which may be an anion in a salt or even an oxide such as a mixed oxide with other metals present in the catalyst. In many instances, analytical techniques may not be sufficient to precisely identify the species present, and the characterization of an oxyanion is not to be understood as limiting the species that may ultimately exist on the catalyst during use (rather, reference to oxyanions is intended to provide guidance as to how the catalyst is to be made).

Particularly preferred anion promoters include the sulfates and oxyanions of rhenium, molybdenum and/or tungsten. Examples of anions of sulfur that can be suitably applied include sulfate, sulfite, bisulfite, bisulfate, sulfonate, persulfate, thiosulfate, dithionate, dithionite, halosulfate, for example, fluorosulfate, etc. Preferred compounds to be applied are ammonium sulfate and the alkali metal sulfates. Examples of anions of molybdenum and tungsten that can be suitably applied include molybdate, dimolybdate, paramolybdate, other iso- and heteropolymolybdates, etc.; and tungstate, paratungstate, metatungstate, other iso- and hetero-polytungstates, etc. Preferred are sulfates, molybdates and tungstates.

Another class of promoters which may be employed in the present invention includes manganese components. In many instances, manganese components can enhance the activity, efficiency and/or stability of catalysts. The identity of the exact manganese species that provides the enhanced activity, efficiency and/or stability is not always certain and may be the component added or that generated either during catalyst preparation or during use as a catalyst. The manganese component can be selected from among manganese acetate, manganese ammonium sulfate, manganese citrate, manganese dithionate, manganese oxalate, manganous nitrate, manganous sulfate, permanganate anion, manganate anion, and the like. Such manganese components are preferably accompanied by a complexing agent, for example, ethylenediaminetetraacetic acid (EDTA), which preferably burns out during the following calcining. Suitable amounts of promoter may vary within wide ranges known to those skilled in the art for each particular promoter.

In accordance with a specific method for impregnating carrier with catalytic material and promoter, an initial impregnation is conducted to impregnate the carrier with a catalytic element or compound, followed by a second impregnation in which the carrier is impregnated simultaneously with a catalytic material (element and/or compound) and one or more promoter. For example, a suitable sequence for carrying out such a pair of impregnations includes (1) vacuum impregnating into the carrier for 1-20 minutes a solution containing 15-45 weight % of silver, preferably 25-30 weight % of silver, the solution having been prepared by (a) mixing ethylenediamine (high purity grade) with distilled water, (b) slowly adding oxalic acid dihydrate (reagent grade) to the aqueous ethylenediamine solution at ambient conditions, whereupon an exothermic reaction occurs and the solution temperature rises to about 40 degrees C., (c) slowly adding silver oxide, and (d) adding monoethanolamine (Fe and Cl free); then (2) draining off excess impregnation solution; then (3) optionally rinsing the silver-impregnated carrier with a solution which is the same as the above-mentioned silver impregnation solution, except that it does not contain silver oxide or monoethanolamine, that is, a solution of ethylenediamine, water and oxalic acid, in order to reduce the amount of large (occluding) silver particles on the external surfaces of the catalyst which sometimes can occur upon roasting; (4) draining excess rinsing solution through the exit stopcock of the impregnating tube for approximately 2 to 10 minutes, preferably about 5 minutes; then (5) roasting the silver-impregnated carrier in hot air using a belt roaster at about 400 to 600 degrees C., preferably about 500 degrees C., for about 1 to 10 minutes, preferably about 2.5 minutes, with air flow of about 40 to 90 SCFH/in², preferably about 66 SCFH/in²; then (6) vacuum impregnating the silver impregnated carrier with a second impregnation solution containing silver and promoters for 1-20 minutes, the second impregnation solution having been prepared by (a) mixing ethylenediamine (high purity grade) with distilled water; (b) slowly adding oxalic acid dihydrate (reagent grade) to the aqueous ethylenediamine solution at ambient conditions, whereupon an exothermic reaction occurs and the solution temperature rises to about 40 degrees C., (c) slowly adding silver oxide, (d) adding monoethanolamine (Fe and Cl free), (e) adding one or more promoters and (NH₄)₂H₂(EDTA); (7) then draining off excess impregnation solution; then (8) optionally rinsing the silver- and promoter-impregnated carrier with a solution which is the same as the above-mentioned second impregnation solution, except that it does not contain silver oxide, that is, a solution of ethylenediamine, monoethanolamine, optional promoter, optional (NH₄)₂H₂(EDTA), water and oxalic acid; (9) draining excess rinsing solution through the exit stopcock of the impregnating tube for approximately 2 to 10 minutes, preferably about 5 minutes; and then (10) roasting the silver- and promoter-impregnated carrier in hot air using a belt roaster at about 400 to 600 degrees C., preferably about 500 degrees C., for about 1 to 10 minutes, preferably about 2.5 minutes with air flow of 40-90 SCFH/in², preferably about 66 SCFH/in².

As indicated above, the carriers of the present invention are particularly suitable for use in the production of alkylene epoxide by the vapor phase epoxidation of the corresponding alkylene, particularly ethylene, with molecular oxygen and/or one or more other oxygen-containing compounds. The reaction conditions for carrying out the epoxidation reaction are well-known and extensively described in the prior art. This applies to reaction conditions, such as temperature, pressure, residence time, concentration of reactants, gas phase diluents (for example, nitrogen, methane and CO₂), gas phase inhibitors (for example, ethyl chloride, vinyl chloride and ethylene dichloride), additives and/or other gaseous promoters (for example, those disclosed by Law, et al., in U.S. Pat. Nos. 2,279,469 and 2,279,470, such as nitrogen oxides and nitrogen oxide generating compounds), one or more gaseous efficiency-enhancing member of a redox-half reaction pair (see U.S. Pat. No. 5,504,053, the entirety of which is hereby incorporated herein by reference), or the like. Ethylene epoxidation is a strongly exothermic reaction, and the heat of reaction for combustion of ethylene into CO₂ and H₂O is twelve times that for ethylene epoxide formation. Prompt and efficient removal of the reaction heat from the catalyst and the gas phase is ultimately important because otherwise the further oxidation of ethylene epoxide will be accelerated, resulting in decreased selectivity.

The promoters for catalyst employing the present invention may also be of the type comprising at least one efficiency-enhancing salt of a member of a redox-half reaction pair which is employed in an epoxidation process in the presence of a gaseous component capable of forming a gaseous efficiency-enhancing member of a redox-half reaction pair under reaction conditions. The term “redox-half reaction” is defined herein to mean half-reactions like those found in equations presented in tables of standard reduction or oxidation potentials, also known as standard or single electrode potentials, of the type found in, for instance, “Handbook of Chemistry”, N. A. Lange, Editor, McGraw-Hill Book Company, Inc., pages 1213-1218 (1961) or “CRC Handbook of Chemistry and Physics”, 65th Edition, CRC Press, Inc., Boca Raton, Fla., pages D155-162 (1984). The term “redox-half reaction pair” refers to the pairs of atoms, molecules or ions or mixtures thereof which undergo oxidation or reduction in such half-reaction equations. Such terms as redox-half reaction pairs are used herein to include those members of the class of substance which provide the desired performance enhancement, rather than a mechanism of the chemistry occurring. Preferably, such compounds, when associated with the catalyst as salts of members of a half reaction pair, are salts in which the anions are oxyanions, preferably an oxyanion of a polyvalent atom; that is, the atom of the anion to which oxygen is bonded is capable of existing, when bonded to a dissimilar atom, in different valence states. As used herein, the term “salt” does not imply that the anion and cation components of the salt be associated or bonded in the solid catalyst, but only that both components be present in some form in the catalyst under reaction conditions. Potassium is the preferred cation, although sodium, rubidium and cesium may also be operable, and the preferred anions are nitrate, nitrite and other anions capable of undergoing displacement or other chemical reaction and forming nitrate anions under epoxidation conditions. Preferred salts include KNO₃ and KNO₂, with KNO₃ being most preferred.

The salt of a member of a redox-half reaction pair is added to the catalyst in an amount sufficient to enhance the efficiency of the epoxidation reaction. The precise amount will vary depending upon such variables as the gaseous efficiency-enhancing member of a redox-half reaction used and concentration thereof, the concentration of other components in the gas phase, the amount of silver contained in the catalyst, the surface area of the support, the process conditions, for example, space velocity and temperature, and morphology of support. Alternatively, a suitable precursor compound may also be added such that the desired amount of the salt of a member of a redox-half reaction pair is formed in the catalyst under epoxidation conditions, especially through reaction with one or more of the gas-phase reaction components. Generally, however, a suitable range of concentration of the added efficiency-enhancing salt, or precursor thereof, calculated as cation, is about 0.01 to about 5 percent, preferably about 0.02 to about 3 percent, by weight, based on the total weight of the catalyst. Most preferably the salt is added in an amount of about 0.03 to about 2 weight percent.

The preferred gaseous efficiency-enhancing members of redox-half reaction pairs are compounds containing an element capable of existing in more than two valence states, preferably nitrogen and another element which is, preferably, oxygen. The gaseous component capable of producing a member of a redox-half reaction pair under reaction conditions is a generally a nitrogen-containing gas, such as for example nitric oxide, nitrogen dioxide and/or dinitrogen tetroxide, hydrazine, hydroxylamine or ammonia, nitroparaffins having 1-4 carbon atoms (for example, nitromethane), nitroaromatic compounds (especially nitrobenzene), and or N-nitro compounds, nitriles (for example, acetonitrile). The amount of nitrogen-containing gaseous promoter to be used in these catalysts is that amount sufficient to enhance the performance, such as the activity of the catalyst and particularly the efficiency of the catalyst. The concentration of the nitrogen-containing gaseous promoter is determined by the particular efficiency-enhancing salt of a member of a redox-half reaction pair used and the concentration thereof, the particular alkene undergoing oxidation, and by other factors including the amount of carbon dioxide in the inlet reaction gases. For example, U.S. Pat. No. 5,504,053 discloses that when the nitrogen-containing gaseous promoter is NO (nitric oxide), a suitable concentration is from about 0.1 to about 100 ppm, by volume, of the gas stream.

Although in some cases it is preferred to employ members of the same half-reaction pair in the reaction system, that is, both the efficiency-enhancing salt promoter associated with the catalyst and the gaseous promoter member in the feedstream, as, for example, with a preferred combination of potassium nitrate and nitric oxide, this is not necessary in all cases to achieve satisfactory results. Other combinations, such as KNO₂/N₂O₃, KNO₃/NO₂, KNO₃/N₂O₄, KNO₂/NO, KNO₂/NO₂ may also be employed in the same system. In some instances, the salt and gaseous members may be found in different half-reactions which represent the first and last reactions in a series of half-reaction equations of an overall reaction.

In any event, the solid and/or gaseous promoters are provided in a promoting amount. As used herein the term “promoting amount” of a certain component of a catalyst refers to an amount of that component that works effectively to provide an improvement in one or more of the catalytic properties of that catalyst when compared to a catalyst not containing said component. Examples of catalytic properties include, inter alia, operability (resistance to run-away), selectivity, activity, conversion, stability and yield. It is understood by one skilled in the art that one or more of the individual catalytic properties may be enhanced by the “promoting amount” while other catalytic properties may or may not be enhanced or may even be diminished. It is further understood that different catalytic properties may be enhanced at different operating conditions. For example, a catalyst having enhanced selectivity at one set of operating conditions may be operated at a different set of conditions wherein the improvement shows up in the activity rather than the selectivity and an operator of an ethylene oxide plant will intentionally change the operating conditions in order to take advantage of certain catalytic properties even at the expense of other catalytic properties in order to maximize profits by taking into account feedstock costs, energy costs, by-product removal costs and the like.

The promoting effect provided by the promoters can be affected by a number of variables such as, for example, reaction conditions, catalyst preparation techniques, surface area and pore structure and surface chemical properties of the support, the silver and the concentration of other promoters present in the catalyst, and the presence of other cations and anions present in the catalyst. The presence of other activators, stabilizers, promoters, enhancers or other catalyst improvers can also affect the promoting effects.

The desirability of recycling unreacted feed, or employing a single-pass system, or using successive reactions to increase ethylene conversion by employing reactors in series arrangement can be readily determined by those skilled in the art. The particular mode of operation selected will usually be dictated by process economics.

The present invention is applicable to epoxidation reactions in any suitable reactor, for example, fixed bed reactors and fluid bed reactors, a wide variety of which are well known to those skilled in the art and need not be described in detail herein.

Conversion of ethylene to ethylene epoxide can be carried out, for example, by continuously introducing a feed stream containing ethylene and oxygen to a catalyst-containing reactor at a temperature of from about 200 degrees C. to about 300 degrees C., and a pressure which may vary within the range of from about 5 atmospheres to about 30 atmospheres, depending upon the mass velocity and productivity desired. Residence times in large-scale reactors are generally on the order of about 0.1-5 seconds. Oxygen may be supplied to the reaction in an oxygen-containing stream, such as air or as commercial oxygen, or as oxygen-enriched air. The resulting ethylene epoxide is separated and recovered from the reaction products using conventional methods.

The catalysts disclosed herein can be used under widely varying process conditions, as is well known by those skilled in the art. However, for purposes of defining standard sets of conditions under which the activity, efficiency, stability and other factors obtained using a particular catalyst can be compared, standard sets of process conditions, referred to herein as “Standard Ethylene Epoxidation Process Conditions” are defined as follows:

### Ethylene Epdxidation Process Conditions

A standard back-mixed autoclave with internal gas recycle or a single—pass tubular reactor is used for catalyst testing. There is some variation in ethylene, oxygen and gas phase modifier/promoter feed concentrations depending on the process conditions used. Two cases are illustrated: air process conditions, which simulate typical conditions employed in commercial air-type ethylene epoxide processes where air is used to supply molecular oxygen, and oxygen process conditions, which simulate typical conditions in commercial oxygen-type ethylene epoxide processes where pure oxygen is added as the oxygen source. Each case provides a different efficiency but it is the rule for practically all cases that with air as the oxygen feed, lower amounts of oxygen and ethylene are used which will yield an efficiency to ethylene epoxide which is about 2 to 5 percentage points lower than that when pure oxygen is employed as oxygen source. Well known, back-mixed, bottom-agitated “Magnedrive” autoclaves described in FIG. 2 of the paper by J. M. Berry entitled “Reactor for Vapor Phase-Catalytic Studies,” in Chemical Engineering Progress, Vol. 70, No. 5, pages 78-84, 1974, are used as one of the reactors. The inlet conditions include the following:

TABLE I
Ethylene Epoxidation Process Conditions

| | Oxygen Process | Oxygen Process | Oxygen Process | Air Process | Air Process | Air Process |
|---|---|---|---|---|---|---|
| | Conditions-I | Conditions-II | Conditions-III | Conditions-I | Conditions-II | Conditions-III |
| Component | Mole % | Mole % | Mole % | Mole % | Mole % | Mole % |
| Ethylene | 30.0 | 30.0 | 30.0 | 10.0 | 11.0 | 11.0 |
| Oxygen | 8.0 | 8.0 | 8.0 | 6.0 | 7.0 | 7.0 |
| Ethane | 0.5 | 0.5 | 0.5 | 0.25 | 0.24 | 0.07 |
| Carbon Dioxide | 3.0 | 3.0 | 0.0 | 6.0 | 5.5 | 5.5 |
| Nitrogen | Balance of gas | Balance of gas | Balance of gas | Balance of gas | Balance of gas | Balance of gas |
| Parts per million | Optimum for | Optimum for | Optimum for | 3.5 ppm | 3.5 ppm | 2.5 ppm |
| Ethyl Chloride | Efficiency | Efficiency | Efficiency | | | |
| Parts per million | None | None | Optimum for | None | None | None |
| Nitric Oxide | | | Efficiency | | | |
| Type of Reactor | CSTR | CSTR | CSTR | Tube | CSTR | CSTR |
| Amount of | 80 cc | 40 cc | 40 cc | 0.5 g | 80 cc | 80 cc |
| Catalyst | | | | | | |
| Total Outlet | 22.6 SCFH | 11.3 SCFH | 11.3 SCFH | 180 cc/min | 22.6 SCFH | 22.6 SCFH |
| Flow Rate | | | | | | |

The pressure is maintained constant at about 200-275 psig and the total outlet flow is maintained at about 11.3 or 22.6 SCFH. SCFH refers to cubic feet per hour at standard temperature and pressure, namely, 0° C. and one atmosphere. Ethyl chloride concentration is adjusted to maintain maximum efficiency. Temperature (° C.) and catalyst efficiency are typically obtained as the responses describing the catalyst performance. The catalyst test procedure used for autoclaves in the Ethylene Epoxidation Process Conditions is as follows: 40 or 80 cc of catalyst is charged to the back-mixed autoclave and the weight of the catalyst noted. The back-mixed autoclave is heated to about reaction temperature in a nitrogen flow of 10 or 20 SCFH with the fan operating at 1500 rpm. The nitrogen flow is then discontinued and the above-described feed stream introduced into the reactor. The total gas outlet flow is adjusted to 11.3 or 22.6 SCFH. The temperature is adjusted over the next few hours to provide the desired outlet ethylene oxide. The optimum efficiency may be obtained by adjusting ethyl chloride. The outlet epoxide concentration is monitored to make certain that the catalyst had reached its peak steady state performance. The ethyl chloride may be periodically adjusted, and the efficiency of the catalyst to ethylene epoxide and the rate of deactivation (temperature rise and/or efficiency loss) are thus obtained.

The catalyst test procedure used for the tubular reactor in the Ethylene Epoxidation Process Conditions is the following: Approximately 5 g of catalyst is crushed with a mortar and pestle, then sieved to 30/50 U.S. Standard mesh. From the meshed material, 0.5 g. is charged to the microreactor made of 0.25 inch OD stainless steel (wall thickness 0.035 inches). Glass wool is used to hold the catalyst in place. The reactor tube is fitted into a heated brass block which has a thermocouple placed against it. The block is enclosed in an insulated box. Feed gas is passed over the heated catalyst at a pressure of 200 psig. The reactor flow is adjusted and recorded at standard pressure and room temperature.

The standard deviation of a single test result reporting catalyst efficiency in accordance with the procedures described above is about 0.5% efficiency units. The typical standard deviation of a single test result reporting catalyst activity in accordance with the procedure described above is about 2° C. The standard deviation, of course, will depend upon the quality of the equipment and precision of the techniques used in conducting the tests, and thus will vary. The test results reported herein are believed to be within the standard deviation set forth above.

In determining activity and efficiency, the process and catalyst should be under steady state conditions. They can often be ascertained promptly upon steady state conditions being achieved.

The properties of the starting carrier materials and the specifics of their modifications are detailed in Table II. In Table III are set forth the specifics of washing some of the modified carriers. In Table IV are set forth the specifics of the catalyst preparations on the carriers, including catalyst compositions.

### Modified Carrier Preparations

A quantity of α-alumina is vacuum impregnated with an alkali metal silicate solution (see Table II). The alkali metal silicate solution is added to a glass or stainless steel vessel which is equipped with suitable stopcocks for impregnating the carrier under vacuum. A suitable separatory funnel containing the impregnating solution is inserted through a rubber stopper into the top of the impregnating vessel. The impregnating vessel containing the carrier is evacuated to approximately 1 to 2 inches of mercury pressure (absolute) for 10 to 30 minutes, after which the impregnating solution is slowly added to the carrier by opening the stopcock between the separatory funnel and the impregnating vessel. After all the solution empties into the impregnating vessel (˜15 seconds), the vacuum is released and the pressure returned to atmospheric. Following addition of the solution, the carrier remains immersed in the impregnating solution at ambient conditions for 10 to 30 minutes, and is thereafter drained of excess solution for 10 to 30 minutes.

The impregnated carrier is dried by placing it in a single layer on stainless steel wire mesh trays which are then placed in a drying oven. Temperature increase schedules are used to slowly dry the impregnated supports (see Table II). After drying, the oven is turned off and the door is opened so that rapid cooling begins, or in some cases, the samples are left overnight to cool. Alternatively, a controlled humidity oven is used to dry the impregnated carrier at equivalent conditions (see Table II).

The impregnated and dried carrier are then calcined in one or more ceramic trays that are placed in a high temperature electric furnace and subjected to a heat treatment (given in Table II). The temperature is slowly raised to the maximum calcining temperature where it is sustained for two to four hours. After the temperature schedule is completed, the furnace is turned off. In some cases, the door is opened so that rapid cooling will begin. The resulting carrier is weighed, and the alkali metal silicate loading is calculated (results given in Table II). Alternatively, larger scale equipment is used to produce larger quantities of the carrier, and the carrier calcined in a gas-fired tunnel kiln with an equivalent temperature program.

### Modified Carrier Washings

Several methods were used to wash the modified carrier. In the first, the resulting carrier is divided in half and placed in two 40 cc Soxhlet extractors so as not to exceed the fill limits for them. (see Table III) The tops of each extractor are joined to open-ended water condensers with ground glass fittings that are wrapped with Teflon tape. The extractors and condensers are then supported with three-finger clamps which are positioned at the resulting joints. Next, 110 mL of deionized distilled water is added to two tared round bottom flasks which are then joined to the bottoms of the extractors with ground glass fittings that are also wrapped with Teflon tape. Next, the condensers are filled and purged with a slow steady stream of water that flows into the bottom port of the condensers and out the top. The assembled extractors are then lowered until the round bottom flasks are resting in suitable heating mantles. The exposed, upper part of the flasks and the lower ⅔ of the extractors are then wrapped with aluminum foil. Next, the heat on the mantles is regulated until the water starts boiling and are then maintained to provide a steady 5 second drip from the tip of the condensers. A wash cycle, the time needed for the water level inside the extractor to exceed the fill capacity limit which then activates the siphoning process that empties the water from the extractor through the siphoning tube, is completed about every 15 minutes or 4 times an hour. After 12 hours elapsed or ˜48 wash cycles, the heat is removed by turning off the power and by lifting the apparatus out of the heating mantles. The water flowing into the condensers is then turned off after the water inside the round bottom flasks stops boiling.

The flasks and their contents are collected and weighed. The extractors are then separated from the condensers and the wet carrier removed and weighed. Next, the wet carrier is transferred to two 4×22×1 cm stainless steel wire mesh trays and oven-dried for ˜3 hours at 110° C. After drying, the resulting washed and dried carrier are weighed, and the carrier mass change calculated (given in Table III).

In the second washing treatment, the calcined modified carrier is vacuum impregnated with a solution prepared by mixing 250 g of distilled water, 259 g of ethylenediamine, 259 g of oxalic acid dihydrate, 95 g of monoethanolamine and an additional 423 g of distilled water. The carrier is impregnated under vacuum (1-2 inches mercury pressure absolute) with the solution in a manner identical to that given in the modified carrier preparation. After draining, the carrier is roasted in air. It is spread out in a single layer on two stainless steel wire mesh trays then placed on a steel mesh belt and transported through a 2″×2″ square heating zone for 2.5 minutes. The heating zone is maintained at 500° C. by passing hot air upward through the belt and about the carrier particles at the rate of 266 standard cubic feet per hour (SCFH). After being roasted in the heating zone, the washed carrier is cooled in the open air to room temperature. In the third washing treatment, the modified carrier is vacuum impregnated with distilled room temperature water. The water-impregnated carrier is placed in ceramic dishes in 1-2 layers and dried in a vacuum oven set at 9 inches mercury pressure absolute for four hours. The entire process is repeated two more times using new water solutions each time.

TABLE II
Carrier Post Treatments

| Carrier | A | B | C | D | E | F | G |
|---|---|---|---|---|---|---|---|
| Starting Carrier | AA | AA | AA | AA | AA | BB | BB |
| Pore Volume, cc/g | 0.72 | 0.72 | 0.72 | 0.72 | 0.72 | 0.67 | 0.67 |
| Packing Density, g/cc | 0.518 | 0.518 | 0.518 | 0.518 | 0.518 | 0.557 | 0.557 |
| Surface Area, m2/g | 1.13 | 1.13 | 1.13 | 1.13 | 1.13 | 0.86 | 0.86 |
| Weight, g | 77.70 | | 155.64 | 90.84 | 41.37 | 2745 | 100.01 |
| Impregnation Solution | | | | | | | |
| Alkali metal Silicate | 14% NaOH + | none | 14% NaOH + | 11% K₂O + | 11% K₂O + | 14% NaOH + | 14% NaOH + |
| Solution. | 27% SiO2 | | 27% SiO2 | 24% SiO2 | 24% SiO2 | 27% SiO2 | 27% SiO2 |
| Soln. Weight, g. | 5.13 | | 10.26 | 3-49 | 0.80 | 187.5 | 7.5 |
| Added Water, g. | 145.79 | | 289.76 | 171.51 | 79.21 | 5000 | 200.0 |
| Drying | | | | | | | |
| Max. Temp., C. | 250 | | 150 | 90 | 90 | 120 | 150 |
| Time, hr. | 0.5 | | 0.7 | 0.9 | 0.9 | 1.9 | 0.7 |
| Calcination | | | | | | | |
| Max. Temp., C. | 1200 | | 1200 | 1200 | 1200 | 1400 | 1400 |
| Time, hr. | 2 | | 2 | 2 | 2 | 4 | 4 |
| | | | | | | tunnel kiln | |
| Modified Carrier, g | 78.45 | | 157.03 | 91.28 | 41.45 | | 100.21 |
| Total deposited, g | 0.75 | | 1.39 | 0.44 | 0.08 | | 0.20 |
| Mass % deposited | 0.953 | | 0.883 | 0.478 | 0.19 | | 0.20 |
| Surface Area, m2/g | 1.08 | | 1.04 | 1.25 | 1.25 | 0.74 | 0.74 |
| Washing? | No | No | Yes | Yes | Yes | No | Yes |

| Carrier | H | I | J | K | L | M | N |
|---|---|---|---|---|---|---|---|
| Starting Carrier | CC | BB | BB | DD | EE | EE | EE |
| Pore Volume, cc/g | 0.65-0.67 | 0.67 | 0.67 | 0.60 | 0.68 | 0.68 | 0.68 |
| Packing Density, g/cc | 0.549-0.559 | 0.557 | 0.557 | | 0.605 | 0.605 | 0.605 |
| Surface Area, m2/g | 0.97-1.04 | 0.86 | 0.86 | 0.82 | 1.12 | 1.12 | 1.12 |
| Weight, g | | 111.74 | 111.63 | | 98.28 | 98.33 | 64.30 |
| Impregnation Solution | | | | | | | |
| Alkali metal Silicate | none | 14% NaOH + | 14% NaOH + | 14% NaOH + | 14% NaOH + | 14% NaOH + | none |
| Soln. | | 27% SiO2 | 27% SiO2 | 27% SiO2 | 27% SiO2 | 27% SiO2 | |
| Soln. Weight, g. | | 7.37 | 7.36 | | 7.89 | 25.58 | |
| Added Water, g. | | 192.65 | 192.66 | | 210.00 | 209.99 | |
| Drying | | | | | | | |
| Max. Temp., C. | | 150 | 150 | 150 | 120 | 120 | |
| Time, hr. | | 0.7 | 0.7 | 4 | 1.9 | 1.9 | |
| | | | | (contr. | | | |
| | | | | humidity) | | | |
| Calcination | | | | | | | |
| Max. Temp., C. | | 1400 | 1400 | 1400 | 1400 | 1400 | |
| Time, hr. | | 4 | 4 | 4 | 4 | 4 | |
| Modified Carrier, g | | 112.31 | 112.14 | | 98.93 | 100.38 | |
| Total deposited, g | | 0.57 | 0.51 | | 0.65 | 2.05 | |
| Mass % deposited | | 0.51 | 0.45 | 0.5 | 0.66 | 2.04 | |
| | | | | (target) | | | |
| Surface Area, m2/g | | | | | 0.91 | 0.79 | |
| Washing? | No | No | Yes | Yes | No | No | No |

TABLE III
Washing after Post Treatment

| Carrier | C | D | E | G | J | K |
|---|---|---|---|---|---|---|
| Starting Carrier | AA | AA | AA | BB | BB | DD |
| Pore Volume, cc/g | 0.72 | 0.72 | 0.72 | 0.67 | 0.67 | 0.60 |
| Packing Density, g/cc | 0.518 | 0.518 | 0.518 | 0.557 | 0.557 | |
| Surface Area, m2/g | 1.13 | 1.13 | 1.13 | 0.86 | 0.86 | 0.82 |
| Washing | | | | | | |
| Modified carrier Weight, g | 42.65 | 42.28 | 35.43 | 100.21 | 90.17 | 120.34 |
| Type of Washing | Soxhlet | Soxhlet | Soxhlet | Vacuum | Vacuum | Vacuum |
| Wash Solvent | Water | Water | Water | Oxalate | Oxalate | Water |
| | | | | Amine | Amine | |
| Wash Solvent, g. | 110 | 110 | 110 | 228 | 228 | 248.19 |
| Wash Time, hr. | 12 | 12 | 12 | 0.25 | 0.25 | 0.25 |
| Drying Temp, ° C. | 110 | 110 | 110 | 500 | 500 | 120 |
| Drying Time, hr. | 3 | 3 | 3 | 2.5 min. | 2.5 min | 4 |
| Dried Carrier, g. | 42.35 | 42.04 | 35.33 | 101.07 | 90.98 | 120.34 |
| Carrier Mass Change, g. | −0.30 | −0.24 | −0.10 | 0.86 | 0.81 | 0.00 |

### Catalyst Preparations

The resulting carriers are vacuum impregnated (see Table IV) with a first impregnation silver solution typically containing 30 weight % silver oxide, 18 weight % oxalic acid, 17 weight % ethylenediamine, 6 weight % monoethanolamine, and 27 weight % distilled water. The first impregnation solution is prepared by (1) mixing 1.14 parts of ethylenediamine (high purity grade) with 1.75 parts of distilled water; (2) slowly adding 1.16 parts of oxalic acid dihydrate (reagent grade) to the aqueous ethylenediamine solution such that the temperature of the solution does not exceed 40° C., (3) slowly adding 1.98 parts of silver oxide, and (4) adding 0.40 parts of monoethanolamine (Fe and Cl free).

The carrier is impregnated in a appropriately sized glass or stainless steel cylindrical vessel which is equipped with suitable stopcocks for impregnating the carrier under vacuum. A suitable separatory funnel which is used for containing the impregnating solution is inserted through a rubber stopper into the top of the impregnating vessel. The impregnating vessel containing the carrier is evacuated to approximately 1-2″ mercury absolute for 10 to 30 minutes, after which the impregnating solution is slowly added to the carrier by opening the stopcock between the separatory funnel and the impregnating vessel. Specific solution compositions are given in Table IV. After all the solution empties into the impregnating vessel (˜15 seconds), the vacuum is released and the pressure returned to atmospheric. Following addition of the solution, the carrier remains immersed in the impregnating solution at ambient conditions for 5 to 30 minutes, and is thereafter drained of excess solution for 10 to 30 minutes.

The silver-impregnated carrier is then roasted as follows to effect reduction of silver on the catalyst surface. The impregnated carrier is spread out in a single layer on stainless steel wire mesh trays then placed on a stainless steel belt (spiral weave) and transported through a 2″×2″ square heating zone for 2.5 minutes, or equivalent conditions were used for a larger belt operation. The heating zone is maintained at 500° C. by passing hot air upward through the belt and about the catalyst particles at the rate of 266 standard cubic feet per hour (SCFH). After being roasted in the heating zone, the catalyst is cooled in the open air to room temperature and weighed (results given in Table IV).

Next, the silver-impregnated carrier is vacuum impregnated with a second silver impregnation solution containing both the silver oxalate amine solution and the catalyst promoters. The second impregnation solution is composed of all of the drained solution from the first impregnation plus a fresh aliquot of the first solution, or a new solution is used. The promoters, in either aqueous solution or neat form, are added (in the ascending numeric order listed in Table IV) with stirring.

The impregnation, rinsing and roasting steps for this second impregnation are carried out analogously to the first impregnation.

The twice-impregnated carrier, that is, the finished catalyst, is again weighed, and based upon the weight gain of the carrier in the second impregnation, the weight % of silver and the concentration of the promoters are calculated (results given in Table IV). The finished catalyst is then employed in an ethylene epoxidation reaction, the results of which are listed in Tables V, VI, VII and VIII.

TABLE IV
Catalyst Preparations

| Catalyst No. | 1 | 2 | 3 | 4 |
|---|---|---|---|---|
| First Impregnation | | | | |
| Modified carrier ID | A | B | C | D |
| Carrier, g. | 62.33 | 62.60 | 34.33 | 35.08 |
| Silver oxalate amine | 180 | 174 | 100 | 102 |
| solution, g. | | | | |
| Weight Ag in soln., % | 27.71 | 26.50 | 26.50 | 26.50 |
| Soln. density, g/cc | 1.50 | 1.45 | 1.45 | 1.45 |
| 1^{st} Silver loading, g. | 17.41 | 19.06 | 9.67 | 8.41 |
| Silver loading, % | 21.8 | 23.3 | 22.0 | 19.3 |
| Second Impregnation | | | | |
| Silver oxalate amine | 180 | 173 | 100 | 102 |
| solution, g. | | | | |
| Promoter soln. 1 | (NH₄)₂EDTA | (NH₄)₂EDTA | (NH₄)₂EDTA | (NH₄)₂EDTA |
| | 0.4 g EDTA/g | 0.4 g EDTA/g | 0.4 g EDTA/g | 0.4 g EDTA/g |
| Promoter soln. 1, g. | 0.3164 | 02855 | 0.1726 | 0.3600 |
| Promoter soln. 2 | Mn(NO₃)₂ | Mn(NO₃)₂ | Mn(NO₃)₂ | K₂MnEDTA |
| | 0.1536 g Mn/g | 0.1536 g Mn/g | 0.1536 g Mn/g | 0.06 g Mn, |
| | | | | 0.085 g K/g |
| Promoter soln. 2, g. | 0.0795 | 0.0703 | 0.0426 | 0.4582 |
| Promoter soln. 3 | CsOH | CsOH | CsOH | KNO₃ |
| | 0.4391 g Cs/g | 0.4391 g Cs/g | 0.4391 g Cs/g | 0.3867 g K/g |
| Promoter soln. 3, g. | 0.2403 | 0.2149 | 0.1310 | 0.5607 |
| Promoter soln. 4 | Cs₂SO₄ | Cs₂SO₄ | Cs₂SO₄ | |
| | 0.0661 g Cs/g | 0.0661 g Cs/g | 0.0661 g Cs/g | |
| Promoter soln. 4, g. | 1.682 | 1.511 | 0.9137 | |
| Promoter soln. 5 | NH₄ReO₄ | NH₄ReO₄ | NH₄ReO₄ | |
| | 0.6873 g Re/g | 0.6873 g Re/g | 0.6873 g Re/g | |
| Promoter soln. 5, g. | 0.1540 | 0.1387 | 0.0846 | |
| 2^{nd} Silver loading,, g. | 16.14 | 17.96 | 8.66 | 7.84 |
| Total Ag loading, % | 34.9 | 37.0 | 34.7 | 31.5 |
| Promoter 1, ppm | Cs, 728 | Cs, 757 | Cs, 721 | K, 1428 |
| Promoter 2, ppm | SO4, 135 | SO4, 141 | SO4, 133 | Mn, 153 |
| Promoter 3, ppm | Re, 356 | Re, 372 | Re, 356 | |
| Promoter 4, ppm | Mn, 41 | Mn, 42 | Mn, 40 | |

| Catalyst No. | 5 | 6 | 7 | 8 | 9 |
|---|---|---|---|---|---|
| First Impregnation | | | | | |
| Modified carrier ID | E | F | G | H | I |
| Carrier, g. | 30.20 | 120.20 | 75.00 | | 100.22 |
| Silver oxalate amine | 90 | 375 | 443 | | 444 |
| solution, g. | | | | | |
| Weight Ag in soln., % | 26.50 | 25.13 | 25.13 | | 26.80 |
| Soln. density, g/cc | 1.45 | 1.50 | 1.45 | | 1.48 |
| 1^{st} Silver loading, g. | 7.29 | 29.70 | 17.60 | | 25.56 |
| Silver loading, % | 19.5 | 19.8 | 19.0 | | 20.3 |
| Second Impregnation | | | | | |
| Silver oxalate amine | 90 | 367 | 443 | | 444 |
| solution, g. | | | | | |
| Promoter soln. 1 | (NH₄)₂EDTA | (NH₄)₂EDTA | (NH₄)₂EDTA | (NH₄)₂EDTA | (NH₄)₂EDTA |
| | 0.4 g EDTA/g | 0.4 g EDTA/g | 0.4 g EDTA/g | | 0.4 g EDTA/g |
| Promoter soln. 1, g. | 0.3145 | 1.0090 | 1.2785 | | 1.2320 |
| Promoter soln. 2 | K₂MnEDTA | Mn(NO₃)₂ | Mn(NO₃)₂ | Mn(NO₃)₂ | Mn(NO₃)₂ |
| | 0.06 g Mn, | 0.1536 g Mn/g | 0.1536 g Mn/g | | 0.1536 g Mn/g |
| | 0.085 g K/g | | | | |
| Promoter soln. 2, g. | 0.3981 | 0.2488 | 0.3173 | | 0.3070 |
| Promoter soln. 3 | KNO₃ | Cs₂SO₄ | Cs₂SO₄ | Cs₂SO₄ | Cs₂SO₄ |
| | 0.3867 g K/g | 0.7346 g Cs/g | 0.7346 g Cs/g | | 0.7346 g Cs/g |
| Promoter soln. 3, g. | 0.4892 | 0.2148 | 0.2864 | | 0.2759 |
| Promoter soln. 4 | | CsOH | CsOH | CsOH | CsOH |
| | | 0.068 g Cs/g | 0.068 g Cs/g | | 0.068 g Cs/g |
| Promoter soln. 4, g. | | 0.7807 | 0.8470 | | 0.1272 |
| 2^{nd} Silver loading,, g. | 6.69 | 29.15 | 17.80 | | 24.11 |
| Total Ag loading, % | 31.5 | 32.9 | 32.0 | 32.7 | 33.1 |
| Promoter 1, ppm | K, 1410 | Cs, 709 | Cs, 368 | Cs, 552 | Cs, 348 |
| Promoter 2, ppm | Mn, 151 | SO4, 132 | SO4, 104 | SO4, 150 | SO4, 99 |
| Promoter 3, ppm | | Mn, 39 | Mn, 67 | Mn, 94 | Mn, 64 |
| Catalyst No. | 10 | 11 | 12 | 13 | 14 |
| First Impregnation | | | | | |
| Modified carrier ID | J | K | L | M | N |
| Carrier, g. | 71.90 | 66.70 | 82.79 | 67.57 | 64.56 |
| Silver oxalate amine | 365 | 368 | 259 | 298 | 263 |
| solution, g. | | | | | |
| Weight Ag in soln., % | 28.70 | 25.95 | 25.47 | 25.47 | 26.26 |
| Soln. density, g/cc | 1.46 | 1.47 | 1.48 | 1.48 | 1.48 |
| 1^{st} Silver loading, g. | 26.62 | 17.41 | 17.35 | 13.38 | 16.24 |
| Silver loading, % | 27.0 | 20.7 | 17.3 | 16.5 | 20.1 |
| Second Impregnation | | | | | |
| Silver oxalate amine | 365 | 367 | 259 | 298 | 263 |
| solution, g. | | | | | |
| Promoter soln. 1 | (NH₄)₂EDTA | (NH₄)₂EDTA | Cs₂SO₄ | Cs₂SO₄ | Cs₂SO₄ |
| | 0.4 g EDTA/g | 0.4 g EDTA/g | 0.1005 g Cs/g | 0.1005 g Cs/g | 0.1005 g Cs/g |
| Promoter soln. 1, g. | 0.8574 | 0.9958 | 2.0478 | 2.4974 | 1.8948 |
| Promoter soln. 2 | Mn(NO₃)₂ | Mn(NO₃)₂ | Na₂SO₄ | Na₂SO₄ | Na₂SO₄ |
| | 0.1536 g Mn/g | 0.1536 g Mn/g | 0.0450 g Na/g | 0.0450 g Na/g | 0.0450 g Na/g |
| Promoter soln. 2, g. | 0.2122 | 0.2478 | 2.3342 | 2.8465 | 2.1598 |
| Promoter soln. 3 | Cs₂SO₄ | Cs₂SO₄ | | | |
| | 0.7346 g Cs/g | 0.7346 g Cs/g | | | |
| Promoter soln. 3, g. | 0.1916 | 0.2134 | | | |
| Promoter soln. 4 | CsOH | CsOH | | | |
| | 0.068 g Cs/g | 0.068 g Cs/g | | | |
| Promoter soln. 4, g. | 0.0874 | 0.7763 | | | |
| 2^{nd} Silver loading,, g. | 7.84 | 16.21 | 16.32 | 12.31 | 15.39 |
| Total Ag loading, % | 32.4 | 33.5 | 28.9 | 27.5 | 32.9 |
| Promoter 1, ppm | Cs, 276 | Cs, 354 | Cs, 436 | Cs, 435 | Cs, 440 |
| Promoter 2, ppm | SO4, 78 | SO4, 96 | Na, 223 | Na, 222 | Na, 225 |
| Promoter 3, ppm | Mn, 47 | Mn, 64 | | | |

### Examples 1-5

In Examples 1-5, catalyst numbers 1-5 are tested at the conditions noted in Table I to show the effects of the various post treatment carrier modifications on catalyst activity, efficiency and longevity. Comparative Catalyst 2 has no added alkali metal silicate or washing.

TABLE V
Catalyst Performance Over Time

| | | 2 | | | |
|---|---|---|---|---|---|
| Catalyst | 1 | Comparative | 3 | 4 | 5 |
| Carrier | A | B | C | D | E |
| Process Conditions | Oxygen-I | Oxygen-II | Oxygen-II | Oxygen-III | Oxygen-III |
| Initial Parameters | 2 ppm ECI; | 2 ppm ECI; | 2 ppm ECI; | 6 ppm ECI; | 6 ppm ECI; |
| | Day 8 | Day 2 | Day 4 | 9 ppm NO; | 9 ppm NO; |
| | | | | Day 9 | Day 10 |
| Final Parameters | 2 ppm ECI; | 2 ppm ECI; | 2 ppm ECI; | 8 ppm ECI; | 6 ppm ECI; |
| | Day 60 | Day 26 | Day 24 | 10 ppm NO; | 14 ppm NO; |
| | | | | Day 18 | Day 24 |
| Initial Outlet EO (%) | 1.85 | 1.59 | 1.51 | 2.00 | 2.00 |
| Initial Temperature (° C.) | 240 | 240 | 240 | 251 | 258 |
| Final Outlet EO (%) | 1.50 | 0.61 | 1.30 | 2.00 | 2.00 |
| Final Temperature (° C.) | 250 | 240 | 240 | 253 | 247 |
| Initial Eff. (%) | 81.5 | 84.4 | 85.5 | 84.3 | 81.3 |
| Final Eff. (%) | 81.5 | 82.9 | 86.2 | 83.1 | 83.5 |
| Days | 52 | 24 | 20 | 9 | 14 |
| EO (%)/Day | −0.007 | −0.041 | −0.011 | | |
| Temp. (° C.)/Day | | | | +0.133 | −0.829 |
| Eff. (%)/Day | +0.000 | −0.063 | +0.035 | −0.133 | +0.157 |

### Example 6

One-half gram of Catalyst 6, which was prepared on a sodium silicate-treated carrier without washing, was tested in a microreactor under Air Process Conditions-I given in Table I. At a constant outlet ethylene oxide production of 1.40 mol. %, the initial selectivity of Catalyst 6 was 79.2%, but increased to a maximum of 80.2% after the catalyst had produced 20,000 pounds of EO per cubic foot of catalyst (measured for whole pills). The initial temperature was 258° C., but decreased to 254° C. by 5,000 pounds of EO produced per cubic foot of catalysts. Temperature was 256° C. at the maximum efficiency. After 25,000 pounds EO production, the ethane feed was decreased to zero and the ethyl chloride decreased to 1.2 ppm. Under these conditions, the efficiency decreased from 80.2 to 79.9%, and the temperature increased from 263° C. to 264° C. as the catalyst produced from 25,000 to 45,000 pounds of EO per cubic foot of catalyst.

### Example 7-8

Catalyst 7 was prepared on washed modified Carrier G. Comparative Catalyst 8 was prepared similarly to Catalyst 7 except that the carrier was not modified with sodium silicate. Table VI summarizes performance for producing 1.4% outlet EO under the Air Process Conditions-II defined in Table I.

TABLE VI
Catalyst Performance Over Time

| | Efficiency % | | | Temp. ° C. | | |
|---|---|---|---|---|---|---|
| | 5 Mlb | 25 Mlb | 45 Mlb | 5 Mlb | 25 Mlb | 45 Mlb |
| | EO/CF | EO/CF | EO/CF | EO/CF | EO/CF | EO/CF |
| Catalyst 7 | 77.6 | 77.4 | 77.0 | 249 | 250 | 253 |
| Catalyst 8 | 79.5 | 77.8 | 75.0 | 241 | 254 | 263 |
| Comparative | | | | | | |

### Examples 9-11

Table VII compares the initial performance of Catalysts 9-11 under Air Process Conditions-II at constant outlet ethylene oxide of 1.4 mol %. Catalyst 9 did not receive the washing treatments, but is introduced here as a comparison to the catalysts which did receive washing. Results are shown after seven days of operation, or after about 2,000 pounds of EO/cubic foot of catalyst were produced.

TABLE VII
Effect of Washing

| | | | Efficiency % @ | Temperature ° C. @ |
|---|---|---|---|---|
| Catalyst | Carrier | Washing Treatment | 1.4% Outlet EO | 1.4% Outlet EO |
| 9 | I | None | 74.5 | 265 |
| 10 | J | Amine/oxalate/water; | 77.5 | 255 |
| | | 500° C. roast | | |
| 11 | K | Triple water wash; | 76.7 | 244 |
| | | 120° C. dry | | |

### Examples 12-14

Table VIII compares the performance of Catalysts 12-14 under Air Process Conditions-III at 1.4 mol % outlet EO. Comparative Catalyst 14 did not receive the sodium silicate modification of the carrier.

TABLE VIII
Catalyst Performance

| Catalyst | Carrier | Day | Efficiency % | Temp. ° C. |
|---|---|---|---|---|
| 12 | L | 8 | 78.20 | 253.0 |
| | | 58 | 76.76 | 260.5 |
| 13 | M | 8 | 76.44 | 256.7 |
| 14 | N | 8 | 73.73 | 267.1 |
| Comparative | | | | |

1. A method for the preparation of a modified carrier for a catalyst to be used for the vapor phase epoxidation of alkene, comprising:
a) impregnating a preformed alpha-alumina carrier, wherein said preformed carrier comprises particles which have at least one substantially flat major surface having a lamellate or platelet morphology and wherein said carrier has been subjected to calcining and, optionally, other preforming treatments, as part of the preforming process, with at least one modifier selected from among alkali metal silicates and alkaline earth metal silicates;
b) drying said impregnated carrier; and
c) calcining said dried carrier to react the modifier with a surface of the alpha-alumina.

2. The method of claim 1, wherein said modifier is selected from a group consisting of sodium silicates, lithium silicates and potassium silicates or mixtures thereof.

3. The method of claim 1, wherein said modifier is a sodium silicate with stoichiometry, Na2O-2.6 SiO2.

4. The method of claim 1, wherein said drying is carried out at a temperature not exceeding about 250 degrees C. for at least the first two hours following said impregnation.

5. A method for the preparation of a catalyst to be used for the vapor phase epoxidation of alkene, comprising:
a) impregnating a preformed alpha-alumina carrier, wherein said preformed carrier comprises particles which have at least one substantially flat major surface having a lamellate or platelet morphology and wherein said carrier has been subjected to calcining and, optionally, other preforming treatments, as part of the preforming process, with at least one modifier selected from among alkali metal silicates and alkaline metal earth silicates
b) drying said impregnated carrier;
c) calcining said dried carrier; and
d) depositing silver catalytic material on said dried carrier to react the modifier with a surface of the alpha-alumina.

6. The method of claim 5 further comprising depositing at least one efficiency enhancing promoter is deposited on said dried, calcined, carrier.

7. The method of claim 6 wherein said efficiency enhancing promoter is selected from a group consisting of at least one alkali metal, alkaline earth metal or oxyanion of an element, other than oxygen, having an atomic number of 5 to 83 and being selected from groups 3b through 7b and 3a through 7a of the Periodic Table.

8. The method of claim 6 wherein the said efficiency enhancing promoter is a salt of a member of a redox-half reaction pair.

9. The method of claim 6 wherein said efficiency enhancing promoter is a rhenium component.

10. The method of claim 1 or 5 where in said alkene is ethylene.

11. A modified carrier for a catalyst to be used for the vapor phase epoxidation of alkene prepared by a method comprising:
a) impregnating a preformed alpha-alumina carrier with at least one modifier selected from among alkali metal silicates and alkaline earth metal silicates;
b) drying said impregnated carrier; and
c) calcining said dried carrier.

12. A novel catalyst to be used for the vapor phase epoxidation of alkene prepared by a method comprising:
a) impregnating a preformed alpha-alumina carrier with at least one modifier selected from among alkali metal silicates and alkaline earth metal silicates;
b) drying said impregnated carrier;
c) calcining said dried carrier; and
d) depositing silver catalytic material on said dried carrier

13. The method of claim 1 wherein the preformed alpha-alumina carrier comprises alumina having at least 95% by weight alpha-alumina, and a surface area of at least about 0.5 m2/g, a pore volume of at least about 0.5 cc/g, and a median pore diameter between about 1 to 25 microns.

14. The method of claim 13 wherein the modifier is a sodium silicate with stoichiometry, Na2O-2.6 SiO2.

15. The method of claim 1 or 13 wherein said modified carrier is washed after calcination.
